(19) United States
(12) Patent Application Publication
(10) Pub. No.: US 2024/0211090 A1
(43) Pub. Date: Jun. 27, 2024

(54) METHODS AND SYSTEMS FOR DISPLAYING VIRTUAL ELEMENTS IN AN XR ENVIRONMENT

(71) Applicant: Rovi Guides, Inc., San Jose, CA (US)

(72) Inventors: Charles Dasher, Lawrenceville, GA (US); Christopher Phillips, Hartwell, GA (US)

(21) Appl. No.: 18/088,067

(22) Filed: Dec. 23, 2022

(51) Int. Cl. G06F 3/04815; G06F 3/01

(52) U.S. Cl. CPC G06F 3/04815; G06F 3/011

(57) ABSTRACT

Systems and methods are described for determining a position of a user device in a field of view of a user in an XR environment. One or more display elements are generated for display in the XR environment relative to the position of the user device in the field of view. Each display element comprises a user interface of an executable application for controlling the user device

### BACKGROUND

The present disclosure relates to methods and systems for displaying virtual elements in an XR environment. Particularly, but not exclusively, the present disclosure relates to providing, in an XR environment, one or more virtual display elements each corresponding to an application executable by a user device.

### SUMMARY

Extended reality (XR) experiences, such as virtual, augmented and mixed reality experiences and gaming, provide environments in which a user can interact with virtual objects, either hosted within an XR environment or projected into (or as an overlay in) the real world. An XR environment can be provided by a headset that can detect and map a 3D space and, in many cases, detect and track real world objects using computer vision software within a 3D coordinate system. Real-world user devices, such as mobile phones or wearables, can concurrently run multiple applications at the same time. As such, it is desirable to facilitate interaction with an application running on a user device (or elsewhere, such as on a remote server) in an XR environment.

Systems and methods are provided herein for improving interaction with a user device in an XR environment, e.g., by providing simultaneous access, in the XR environment, to multiple applications for controlling the user device. For example, one or more virtual display elements may be provided, each comprising a user interface for controlling a function of the user device. For example, a display element may be provided to access an application running in the background of a user device, without navigating away from displaying an application running in the foreground of the user device.

According to the systems and methods described herein, a position of a user device, e.g., a watch, a phone, a monitor, a wearable, is determined in a field of view of a user in an XR environment. One or more display elements are generated for display in the XR environment, e.g., using an XR device, relative to the position of the user device in the field of view. Each display element comprises a user interface of an executable application for controlling the user device. For example, each virtual display element in the XR environment may provide access to an application controlling a background function of the user device.

In some examples, the executable application is executable, at least in part, by the user device. In some examples, the executable application is executable, at least in part, at a server. In some examples, the application is executed by the user device and the one or more display elements are generated for display, e.g., rendered, by the XR device.

In some examples, the position of the user device is monitored. In some examples, the position of the one or more display elements is updated as the position of the user device changes, e.g., to maintain the spatial relationship between the user device and the display elements as the user device moves in the XR environment.

In some examples, an anchor point of the user device is determined, e.g., using a trackable feature displayed on the user device or a physical feature of the user device. The one or more display elements may be generated for display relative to the anchor point. In some examples, the anchor point of the user device is a primary anchor point, e.g., that is used to position and/or orientate the one or more display elements in the XR environment to provide access to respective virtual interfaces.

In some examples, the user device and the XR device are in operable communication to share data therebetween. For example, communication between the user device and the XR device may be for the purpose of exchanging data relating to the position of the user device relative to the XR device. For example, inertial measurement unit (IMU) data may be shared between the user device and the XR device. Data relating to the position of the user device relative to the XR device may be used to determine or otherwise aid in the positioning of the one or more display elements in the XR environment.

In some examples, the position of the one or more display elements in the XR environment relative to the position of the user device is defined by a predetermined layout (e.g., pattern) corresponding to a type of user input, such as a button press, a dial rotation, an input to a virtual slider, and/or a user gesture. In some examples, a type of user input is determined, e.g., using sensors of the user device and/or an XR system. The one or display elements may be generated for display in the predetermined layout.

In some examples, the position of the one or more display elements in the XR environment relative to the position of the user device is defined by a predetermined layout based on user activity relating to each executable application.

In some examples, a command to switch between usage of executable applications is received, e.g., at the user device. The one or more display elements maybe generated for display in response to receiving the command.

In some examples, it is determined whether the user device is in a predetermined region of the field of view of the user in an XR environment. The one or more display elements maybe generated for display in response to the user device being within the predetermined region. In some examples, the predetermined region is a region of the XR environment in which a user is more likely to view and be able to interact with a user device, such as a region at an eye level of a user and/or within arm's length of the user.

In some examples, the one or more display elements transition between a first display state, e.g., a transparent or semi-transparent state, and a second display state, e.g., a non-transparent state, as the user device moves into the predetermined region. In some examples, the transition between display states is based on a type of user input, e.g., a gesture of a user.

In some examples, a secondary anchor point is defined. The secondary anchor point may be an anchor point of the XR environment. In some examples, the one or more display elements may be transitioned from the anchor point of the XR environment towards the anchor point of the user device, e.g., as the user device moves towards or into the predetermined region.

In some examples, a level of user interaction with a first display element is determined, e.g., by virtue of gaze tacking or other interaction. In some examples, the position and/or appearance of the first display element is modified in response to the level of user interaction being above a threshold level. For example, a display element with which a user is interacting may be increased in size to improve functionality of the user interface provided by the display element.

In some examples, a user interface provided by one of the display elements may be controlled by virtue of interaction with the user device. For example, an input to a screen of a physical user device may cause selection of a virtual button in a display element.

In some examples, the XR environment is an AR or MR environment. A display screen (e.g., rendered via a virtual or digital twin) that functions as a display of the user device may generated for display, e.g., rendered, in the AR or MR environment, e.g., using an AR or MR device. In some examples, the rendered display screen of the user device comprises a user interface for controlling an application executed by the user device. In some examples, the rendered display screen comprises a virtual user interface for controlling the executable application. In some examples, the virtual user interface of the rendered display screen mimics the functionality of the user inface of the user device. In some examples, the virtual display screen may be positioned, in the AR or MR environment, relative to, e.g., overlaying, a physical display screen of the user device. In some examples, the display screen rendered by the AR or MR device is rendered by an emulator (e.g., implemented by the AR or MR device, or by a server in the cloud). In some examples, a similar display screen to that described in this paragraph may be generated by another device, such as a server in the cloud. Such a display from a server may be provided by way of an emulator or virtual device implemented at the server.

In some examples, the XR environment is a VR environment. A virtual twin of a physical user device maybe generated, e.g., rendered, by a VR device. In some examples, the virtual twin may be positioned in the VR environment based on a determined position of the physical user device. In some examples, the virtual twin comprises a virtual display having a user interface for controlling an application executable by the user device.

In some examples, the one or more display elements may each correspond to a portion a user interface of an executable application.

According to the systems and methods described herein, a position of a user device, e.g., an analogue device, such a watch, is determined in a field of view of a user in an XR environment. One or more display elements are generated for display in the XR environment relative to the position of the user device in the field of view. Each display element comprises a user interface of an executable application relating to the user device. For example, each virtual display element in the XR environment may provide access to an application controlling content provided by a manufacturer of the user device.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of the system for generating one or more display elements in an XR environment, in accordance with some examples of the disclosure;

FIG. 2 is a block diagram showing components of an example system for generating one or more display elements in an XR environment, in accordance with some examples of the disclosure;

FIG. 3 is a flowchart representing a process for generating one or more display elements in an XR environment, in accordance with some examples of the disclosure;

FIG. 4 illustrates one or more display elements positioned relative to a user device in an XR environment, in accordance with some examples of the disclosure;

FIG. 5 illustrates one or more display elements positioned relative to a user device in an XR environment, in accordance with some examples of the disclosure;

FIG. 6 illustrates one or more display elements positioned relative to a user device in an XR environment, in accordance with some examples of the disclosure;

FIG. 7 is a flowchart representing a process for generating one or more display elements in an XR environment, in accordance with some examples of the disclosure;

FIG. 8 illustrates generating one or more display elements positioned relative to a user device in an XR environment, in accordance with some examples of the disclosure;

FIG. 9 illustrates generating one or more display elements positioned relative to a user device in an XR environment, in accordance with some examples of the disclosure;

FIG. 10 illustrates generating one or more display elements positioned relative to a user device in an XR environment, in accordance with some examples of the disclosure;

FIG. 11 illustrates generating one or more display elements positioned relative to a user device in an XR environment, in accordance with some examples of the disclosure;

FIG. 12 illustrates generating one or more display elements positioned relative to a user device in an XR environment, in accordance with some examples of the disclosure;

FIG. 13 illustrates modifying the appearance of a display element positioned relative to a user device in an XR environment, in accordance with some examples of the disclosure;

FIG. 14 illustrates generating one or more display elements positioned relative to a user device in an XR environment, in accordance with some examples of the disclosure; and

FIG. 15 illustrates generating one or more display elements positioned relative to a user device in an XR environment, in accordance with some examples of the disclosure.

### DETAILED DESCRIPTION

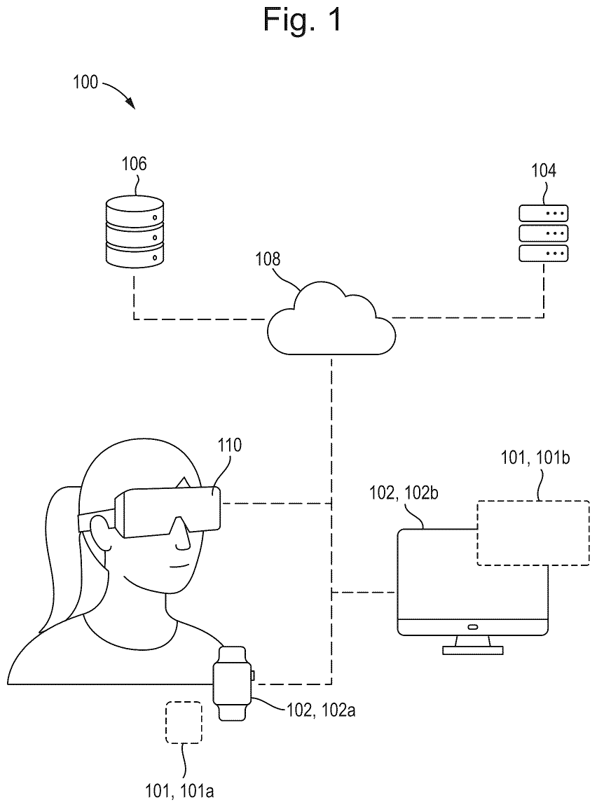

FIG. 1 illustrates an overview of a system 100 for generating one or more display elements 101, e.g., virtual display elements and virtual overlays, in an XR environment. In particular, the example shown in FIG. 1 illustrates a user having an XR device 110, such as a head-mounted display (HMD) as depicted in the appended figures, communicatively coupled to a server 104 and a content item database 106, e.g., via network 108. In this manner, the XR device 110 provides the user with access to an XR environment and/or service provided by a content provider operating server 104. For example, the XR environment may be a virtual reality (VR), augmented reality (AR) or mixed reality (MR) environment accessible to user 110 when operating an XR device 110. When the user is in or accessing the XR environment, the user can interact with one or more user devices 102 communicatively coupled to server 104 and content item database 106, e.g., via network 108. For example, the user may interact with one or more user devices 102, such as a smart watch 102a and/or one or more display screens 102b. In particular, the XR environment may be an AR environment or an MR environment provided or facilitated by XR device 110, which allows the user to physically see user device 102 and for one or more virtual display elements 101 to be displayed to the user in the AR/MR environment. In other examples, the XR environment may be a VR environment provided by XR device 110, which provides a virtual arena or environment which allows the user to see a virtual representation of user device 102 and for one or more virtual display elements 101 to be displayed to the user in the VR environment. In some instances, the XR device 110 may provide such a virtual representation of a device or a virtual device that has no physical counterpart.

Each user device 102 may be a physical electronic device or a virtual device. Example physical devices include wearable devices (e.g., smart watches), mobile phones, and tablets. A virtual device may be a software-driven representation or proxy of a physical device (e.g., an emulation instantiated by an emulator). In some instances, a virtual device may be a virtual twin of a physical user device 102.

Generally speaking, a “virtual twin” is a virtual device that is linked or synchronized with a particular physical user device 102. From a user's perspective, the virtual twin and the corresponding user device 102 may always appear to be in the same state. Providing user input to one may result in both changing states, responsive to the user input, to a same state. The user device and its virtual twin may exchange state information via any suitable means of communication. A graphical representation of the virtual twin may be generated and displayed. In some instances, the graphical representation is designed to look like the physical user device to which it corresponds. For example, a graphical representation of a virtual twin to a smart watch may depict a wristband, bezel, and other structural components typically associated with the smart watch. In some instances, a graphical representation of a virtual twin includes a display (e.g., and no other hardware or structural components).

In some examples, an XR environment may be provided to a user by an XR device 110 communicatively coupled to an edge of network 108. In this case, the display element 101 may be a remote rendered display (e.g., capable of providing the same or similar content as that displayed by a physical screen of user device 102), where the content of the display element 101 is encoded at a network edge and sent to the XR device where the rendering is decoded and displayed in the XR environment at spatial coordinates related to the position of the physical user device.

In some examples, the user device 102 comprises control circuitry configured to execute an application and provide, at a display screen of the user device 102, a user interface to control the application, and thus the user device 102. In other examples, server 104 may comprise control circuitry configured to execute an application and cooperate with user device 102 to provide, at a display screen of the user device 102, a remote user interface to control the application, and thus the user device 102. Irrespective of the location at which the application is executed for controlling the user device 102, the user device 102 may be operationally coupled with XR device 110 to provide one or more display elements 101 in the XR environment, the display elements 101 being provided in the XR environment and having a user interface providing functionality for controlling the user device 102, e.g., in a manner substantially similar as to a manner in which a user controls the user device 102 by using a user interface provided at the display screen of the user device.

In the example shown in FIG. 1, the XR device is depicted as head-mounted display 110. However, the XR device may be any appropriate type of device, such as a tablet computer, a smartphone, smart contact lens, or the like, used either alone or in combination, configured to display or otherwise provide access to an XR environment.

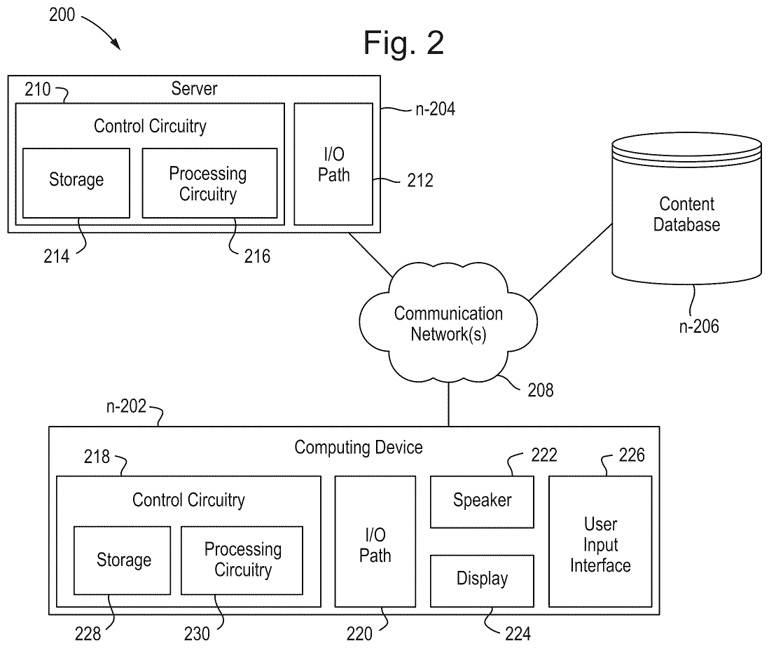

FIG. 2 is an illustrative block diagram showing example system 200, e.g., a non-transitory computer-readable medium, configured to generate display of one or more display elements, e.g., display elements 101, in an XR environment. Although FIG. 2 shows system 200 as including a number and configuration of individual components, in some examples, any number of the components of system 200 may be combined and/or integrated as one device, e.g., as user device 102. System 200 includes computing device n-202 (denoting any appropriate number of computing devices, such as user device 102 and/or XR device 110), server n-204 (denoting any appropriate number of servers, such as server 104), and one or more content databases n-206 (denoting any appropriate number of content databases, such as content database 106), each of which is communicatively coupled to communication network 208, which may be the Internet or any other suitable network or group of networks, such as network 108. In some examples, system 200 excludes server n-204, and functionality that would otherwise be implemented by server n-204 is instead implemented by other components of system 200, such as computing device n-202. For example, computing device n-202 may implement some or all of the functionality of server n-204, allowing computing device n-202 to communicate directly with content database n-206. In still other examples, server n-204 works in conjunction with computing device n-202 to implement certain functionality described herein in a distributed or cooperative manner.

Server n-204 includes control circuitry 210 and input/output (hereinafter “I/O”) path 212, and control circuitry 210 includes storage 214 and processing circuitry 216. Computing device n-202, which may be an HMD, a personal computer, a laptop computer, a tablet computer, a smartphone, a smart television, or any other type of computing device, includes control circuitry 218, I/O path 220, speaker 222, display 224, and user input interface 226. Control circuitry 218 includes storage 228 and processing circuitry 220. Control circuitry 210 and/or 218 may be based on any suitable processing circuitry such as processing circuitry 216 and/or 230. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 214, 228, and/or storages of other components of system 200 (e.g., storages of content database 206, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 214, 228, and/or storages of other components of system 200 may be used to store various types of content, metadata, and or other types of data. Non-volatile memory may also be used (e.g., to launch a boot-up routine and other instructions). Cloud-based storage may be used to supplement storages 214, 228 or instead of storages 214, 228. In some examples, control circuitry 210 and/or 218 executes instructions for an application stored in memory (e.g., storage 214 and/or 228). Specifically, control circuitry 210 and/or 218 may be instructed by the application to perform the functions discussed herein. In some implementations, any action performed by control circuitry 210 and/or 218 may be based on instructions received from the application. For example, the application may be implemented as software or a set of executable instructions that may be stored in storage 214 and/or 228 and executed by control circuitry 210 and/or 218. In some examples, the application may be a client/server application where only a client application resides on computing device n-202, and a server application resides on server n-204.

The application may be implemented using any suitable architecture. For example, it may be a stand-alone application wholly implemented on computing device n-202. In such an approach, instructions for the application are stored locally (e.g., in storage 228), and data for use by the application is downloaded on a periodic basis (e.g., from an out-of-band feed, from an Internet resource, or using another suitable approach). Control circuitry 218 may retrieve instructions for the application from storage 228 and process the instructions to perform the functionality described herein. Based on the processed instructions, control circuitry 218 may determine what action to perform when input is received from user input interface 226.

In client/server-based examples, control circuitry 218 may include communication circuitry suitable for communicating with an application server (e.g., server n-204) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 208). In another example of a client/server-based application, control circuitry 218 runs a web browser that interprets web pages provided by a remote server (e.g., server n-204). For example, the remote server may store the instructions for the application in a storage device. The remote server may process the stored instructions using circuitry (e.g., control circuitry 210) and/or generate displays. Computing device n-202 may receive the displays generated by the remote server and may display the content of the displays locally via display 224. This way, the processing of the instructions is performed remotely (e.g., by server n-204) while the resulting displays, such as the display windows described elsewhere herein, are provided locally on computing device n-202. Computing device n-202 may receive inputs from the user via input interface 226 and transmit those inputs to the remote server for processing and generating the corresponding displays.

A computing device n-202 may send instructions, e.g., to initiate an XR experience and allow a user to view and interact with another user in an XR environment, to control circuitry 210 and/or 218 using user input interface 226.

User input interface 226 may be any suitable user interface, such as a remote control, trackball, keypad, keyboard, touchscreen, touchpad, stylus input, joystick, voice recognition interface, gaming controller, or other user input interfaces. User input interface 226 may be integrated with or combined with display 224, which may be a monitor, a television, a liquid crystal display (LCD), an electronic ink display, or any other equipment suitable for displaying visual images.

Server n-204 and computing device n-202 may transmit and receive content and data via I/O path 212 and 220, respectively. For instance, I/O path 212, and/or I/O path 220 may include a communication port(s) configured to transmit and/or receive (for instance to and/or from content database n-206), via communication network 208, content item identifiers, content metadata, natural language queries, and/or other data. Control circuitry 210 and/or 218 may be used to send and receive commands, requests, and other suitable data using I/O paths 212 and/or 220.

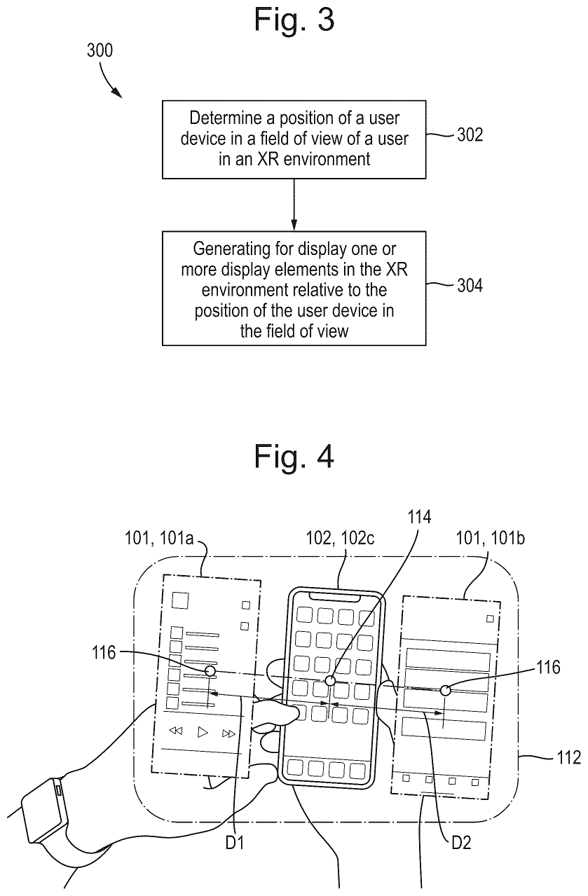

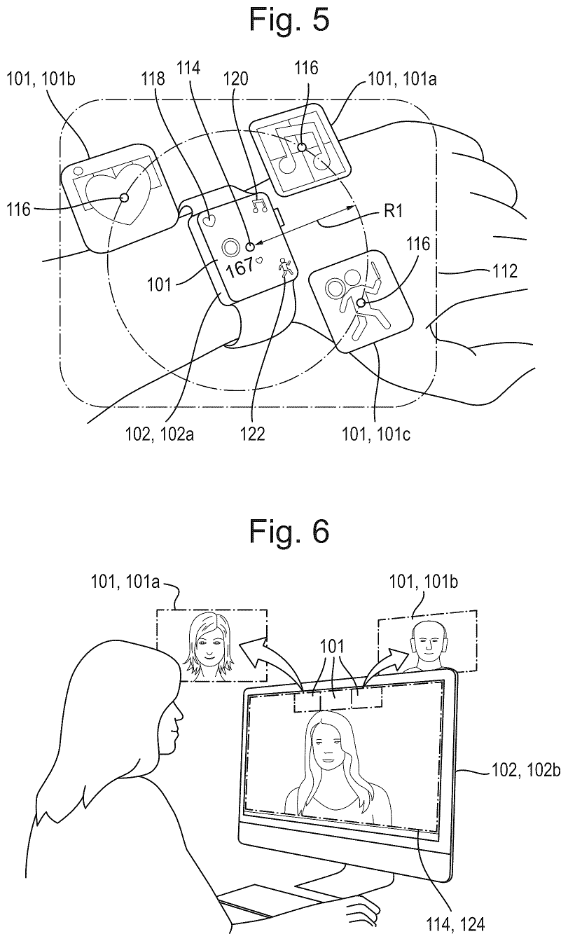

FIG. 3 shows a flowchart representing an illustrative process 300 for generating the display of one or more display elements in an XR environment, such as the display elements 101 shown in FIG. 1. FIG. 4 illustrates virtual display elements positioned relative to a smartphone in an XR environment. FIG. 5 illustrates virtual display elements positioned relative to a smartwatch in an XR environment. FIG. 6 illustrates virtual display elements positioned relative to a display screen in an XR environment. While the example shown in FIGS. 3 to 6 refers to the use of system 100, as shown in FIG. 1, it will be appreciated that the illustrative process 300 shown in FIG. 3, with reference to FIGS. 4 to 6, may be implemented, in whole or in part, on system 100, system 200, and/or any other appropriately configured system architecture. For the avoidance of doubt, the term “control circuitry” used in the below description applies broadly to the control circuitry outlined above with reference to FIG. 2. For example, control circuitry may comprise control circuitry of user device 102, control circuitry of the XR device 110 and control circuitry of server 104, working either alone or in some combination.

At 302, control circuitry, e.g., control circuitry of XR device 110, determines a position of user device 102, e.g., in a field of view of a user in the XR environment. In the context of the present disclosure, the “term field of view of a user” is understood to mean the extent, e.g., at any given moment, to which a user can view an XR environment accessed using an XR device 110. For example, when the XR device 110 is a set of goggles or glasses, the field of view of the user accessing an XR environment is defined by the viewport to the XR environment provided by the goggles or glasses. For example, a user may reposition their head while wearing the goggles or glasses to redefine the content of the viewport. Additionally, or alternatively, an AR/MR environment may be accessed using a smartphone. In such a case the field of view of the user accessing the AR/MR environment is defined by the extent by which the physical world is displayed as an image provided on a display screen, i.e., a viewport, of the smartphone. For example, a user may reposition their smartphone to redefine the content of the viewport. In some examples, the XR device 110 may be an AR contact lens. In such a case, the field of view of the user accessing an AR environment is defined by the user's own field of view, and the user may redefine the viewport by simply looking in a different direction.

In some examples, the XR device 110 may comprise a computer vision system configured to detect objects. For example, the computer vision system may be configured to detect when a wearable (e.g., a watch, smart watch, fitness wearable, etc.) or other physical device (e.g., a monitor, a TV, a smartphone, etc.) is within the field of view of the user in the XR environment (e.g., with a viewport of the XR device 110). In some examples, the computer vision system may calculate an anchor point, or other reference point, based on but not limited to the detected object's size and/or shape (e.g., its geometric center point, a corner point, etc.), a display area of a display screen and/or other physical trackable feature. Further, the user device 102 may assist the computer vision system (e.g., running on XR device 110) by displaying a nonce, a geometric primitive and/or other recognizable “cue”. Additionally, or alternatively, the physical device may assist the computer vision system by providing a plurality of physical “cues” on the device itself, such as but not limited to marks located at various places on the device, such as a digital crown of a watch having a marker, or using a light pulse emitted from a screen of the device. In some examples, the user device 102 may be configured to transmit to the XR device 110 data relating to inertial measurement units (IMU). For example, one or more sensors of the user device 102 may measure movement of the user device 102 and related IMU data may be exchanged with the XR device 110. Within a VR environment, the user device 102 may be a virtual twin of a physical device, or any appropriate representation of a user device 102 in the VR environment provided by a virtual device emulator. In such a case, control circuitry of a VR system may determine an anchor point, or other reference point (e.g., its geometric center point, a corner point, etc.), of a virtual device by analysing an exposed coordinate by the virtual device or through an exposed data point managed by either a virtual device emulator or by the VR device. Irrespective of the manner in which the anchor point is determined, the anchor point may serve as a reference coordinate point within 3D space from which one or more virtual display elements 101 may be located, positioned, orientated, or otherwise anchored, so as to move in 3D space with the virtual device or with the physical device, e.g., as tracked by the computer vision system.

At 304, control circuitry, e.g., control circuitry of user device 102 and XR device 110, generate for display one or more display elements in the XR environment relative to the position of the user device 102 in the field of view. For example, control circuitry of user device 102 and XR device 110 may work together to generate for display in the XR environment a virtual display element 101 comprising a user interface of an application executable by the user device 102 for controlling the user device 102. In some examples, the application may be executed by control circuitry of user device 102 and rendered in the XR environment by control circuitry of XR device 110. In the example shown in FIG. 1, control circuitry generates display element 101a in the XR environment, display element 101a comprising a user interface of an application being run by smartwatch 102a. For example, display element 101a may appear in a similar format in the XR environment to how the user interface of display element 101a would appear as generated on a physical screen of smartwatch 102a. Additionally or alternatively, control circuitry generates display element 101b in the XR environment, display element 101b comprising a user interface of an application being run by monitor 102b. For example, display element 101b may comprise at least a portion of a user interface of an application running on user device 102b. In some examples, display element 101, e.g., display element 101a, may be positioned in the XR environment at a location, e.g., a fixed location, remote from user device 102a, relative to the determined anchor point of user device 102a. In some examples, display element 101, e.g., display element 101b, may be positioned in the XR environment at a location, e.g., a fixed location fixed location (e.g., anchored to a 3D coordinate position of a real-world or virtual environment visible via the XR device 110), at least partially overlaying a screen of user device 102b, relative to the determined anchor point of user device 102b. For the avoidance of doubt, the position and/or orientation of a display element 101 may be any appropriate position (e.g., X, Y, Z coordinates) and/or orientation (e.g., angular measurements indicating roll, pitch, or yaw) within the field of view of the user in the XR environment. In some examples, to facilitate establishing an orientation, one or more display elements 101 may be assigned a center point 116 (e.g., serving as the “center” of the display element) and/or an orientation vector (e.g., serving as a reference vector to determine which way the display element is facing), and determining a position or orientation of the display element may include determining a position of the center point and/or determining an angular roll, pitch, or yaw relative to the orientation vector. For example, the display element 101 may be an overlay so as to fully cover a display screen of user device 102, e.g., so that display element 101 appears, in the XR environment, in the location of a screen of user device 102 (e.g., so that a physical screen of user device 102 cannot be seen in the XR environment when the display element 101 is in a certain position and/or orientation). Additionally, or alternatively, a display element 101 may be positioned remote from the user device 102, e.g., at any appropriate distance from the anchor pint of the user device 102, within the field of view of the user in the XR environment. The actions or descriptions of FIG. 3 may be done in any suitable alternative orders or in parallel to further the purposes of this disclosure. FIGS. 4-6 show various examples of process 300.

In the example shown in FIG. 4, the user device 102 is a smartphone 102c being viewed by a user wearing XR device 110, such as AR glasses. The field of view of the user is depicted by an area within dashed box 112, e.g., which is defined by a size of a viewport of the XR device 110. In FIG. 4, the user has raised smartphone 102c towards their eyeline so that the smartphone 102c is within their field of view 112 and can view a physical display screen of the smartphone 102c. As such, control circuitry of XR device 110 determines a position of the smartphone 102c within the field of view and determines an anchor point 114, e.g., using a computer vision system as described above. In this case, anchor point 114 is defined as a geometric center point of a screen of the smartphone 102c, which is used as a refence point for positioning display elements 101 in the XR environment. For example, control circuitry of XR device 110 may render display elements 101 to provide a user interface to respective applications for controlling user device 102c. In particular, XR device 110 may render a first display element 101a to provide a user interface for controlling a music application executable by user device 102 and a second display element 101b to provide a user interface for controlling an activity tracking application executable by user device 102. Additionally, or alternatively and where technically possible, XR device 110 may render for display in the XR environment a user interface for an application executable by a server, e.g., server 104, for controlling user device 102c. For example, certain aspects of the execution of an application may be carried out by control circuitry of user device 102c and other aspects may be carried out by control circuitry of server 104, e.g., where an application requires execution by a server to perform an operation, such as retrieval of music data from a content database 106, or historic activity data from a user profile. In the example shown in FIG. 4, the location of the first and second display element 101a, 101b is defined by a predetermined layout that sets a center point 116 of display element 101a at a first distance D1 to the left-hand side of user device 102c, and a center point 116 of display element 101b at a second distance D2 (equal to or different from D1) to the right hand side of user device 102c. In some examples, distances D1 and/or D2 may be a default setting, set by a user, or based on various factors, such as the type of application and/or data regarding historic usage of the application. For example, a more frequently used application may appear closer to user device 102c than a less frequently used application.

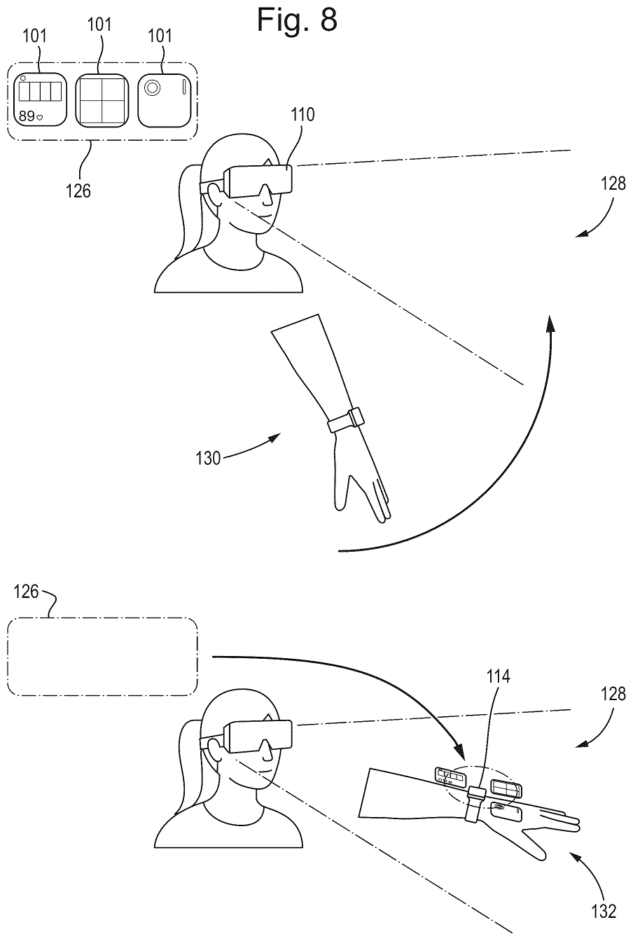

In the example shown in FIG. 5, the user device 102 is a smartwatch 102a being viewed by a user wearing XR device 110, such as VR headset. The field of view of the user is depicted by an area within dashed box 112, e.g., which is defined by a size of a viewport of the XR device 110. In FIG. 5, user device 102a is a digital twin of a physical smartwatch (or other device, such as a VR controller) provided by a virtual device emulator, and, as such, the display screen of the digital twin is a display element 101 within the scope of the present disclosure. In such a case, control circuitry of a VR system may determine anchor point 114 as discussed above, e.g., by analysing an exposed coordinate by the virtual device. In FIG. 5, the user has raised their arm towards their eyeline so that user device 102a is within their virtual field of view 112. As such, control circuitry of XR device 110 determines a position of the smartwatch 102a within the field of view 112 and determines an anchor point 114, e.g., based on a geometrical center of a wireframe model of the digital twin, which is used as a reference point for positioning display elements 101 in the VR environment. For example, control circuitry of XR device 110 may render display elements 101 to provide a user interface to respective applications for controlling smartwatch 102a. In particular, XR device 110 may render a first display element 101a to provide a user interface for controlling a music application executable by smartwatch 102a, a second display element 101b to provide a user interface for controlling an activity tracking application executable by smartwatch 102a, and a third display element 101c to provide a user interface for controlling a fitness application executable by smartwatch 102a. In the example shown in FIG. 5, each of the display elements 101a, 101b, 101c are provided in a predetermined layout such that the center point 116 of each display element is positioned at radius RI from the anchor point 114 of the digital twin. As disclosed above, the layout of the display elements 101a, 101b, 101c may vary according to various factors, such as those described in relation to the examples shown in FIGS. 8 to 10, for example. However, in the example shown in FIG. 5, the generation and position of each of the display elements 101a, 101b, 101c around the anchor point 114 is predetermined based on a setting of user device 102a. For example, the top lefthand corner of the screen of user device 102a comprises a shortcut to access an activity tracking application (see heart icon 118), the top right-hand corner of the screen of user device 102a comprises shortcut to access a music application (see music note icon 120), and the bottom righthand corner of user device 102a comprises a shortcut to access a fitness application (see fitness icon 122). As such, the configurations of the shortcuts on user device 102a, either by default, set by user selection, or set automatically according to historic usage data, determine the relative positions of the display elements 101a, 101b, 101c around the anchor point 114.

In the example shown in FIG. 6, the user device 102 is a monitor 102b being viewed by a user wearing an XR device 110, such as an AR HMD or smart contact lenses in operational communication with external control circuitry. As such, the field of view of the user is defined by what the user is looking at. In the example shown in FIG. 6, the user is looking at user device 102b, which is a computer monitor 102b displaying a video conference session. In this case, control circuitry determines that the user is viewing the physical screen of the monitor 102b, e.g., using a gaze tracking system of monitor 102b, and/or otherwise, e.g., using image analysis of one or more images captured by the smart lenses. In this example, control circuitry defines the anchor point 114 as box 124, which is defined by the edge of the user interface display on the monitor 102b.

In FIG. 6, the user interface of the video conference session comprises multiple display elements 101 for displaying various participants in the video conference session. Each of the display elements 101 are generated in the user's field of view over the physical screen of monitor 102b, e.g., within box 124. A view of the main speaker of the video conference session on the physical display of monitor 102b remains unobscured by the display elements 101. However, in an alternative example, the view of the main speaker of the video conference session may be generated by virtue of a display element 101. However, it may be desirable to minimize the computing power needed to generate the display elements 101 in the XR environment. As such, depending on the application, computing power is reduced as far as practical by generating thumbnail images of the participants in the video conferencing session.

In FIG. 6, the user has decided to view two of the participants in greater detail. For example, a first display element 101a is generated based on one of the thumbnails and a second display element 101b is generated based on another of the thumbnails. In particular, the first and second display elements 101a, 101b may be generated in response to a user selection of one of the thumbnails. In some examples, the user may click and drag one of the thumbnails to a desired location relative to anchor point 114 in the XR environment. In particular, the user may freely place each of display elements 101a, 101b at a desired location and/or orientation relative to anchor point 114. For example, each of display elements 101a, 101b may be place on a different geometrical plane in the XR environment, e.g., relative to a place defined by display screen 102b (or box 124 in a coordinate system of the XR environment). In the example shown in FIG. 6, display element 101a is positioned to the top left of the anchor point, and inclined towards the user, while display element 101b is positioned to the top right of the anchor point, and in a plane behind a plane defined by box 124 in a coordinate system of the XR environment. In some examples, the position and/or orientation of the display elements 101a, 101b may be varied according to an operational state of video conference session. For example, one or more participants may be moved from a thumbnail view to display element 101a, for example, in response to a level, e.g., an increased or decreased level, of participation in the video conferencing session. In this manner, the required operational computing power is increased when a participant is speaking, and reduced when they are not speaking.

In each of the examples shown in FIGS. 4-6, the position of anchor point 114 may be set and/or moved by a user. For example, a user may input one or more setting that define a preferred anchor point of the user. In some examples, the anchor point 114 may be set, e.g., by default, based on one or more setting of the XR device 110. In some examples, the position of the anchor point 114 may be set or moved by virtue of user input, such as using hand gestures or a controller of the XR system.

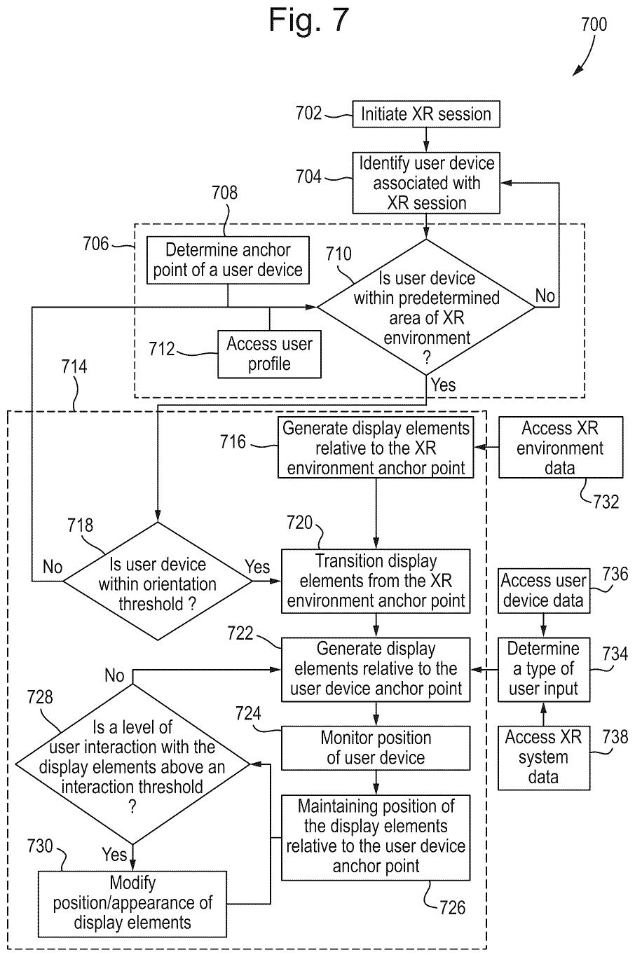

FIG. 7 shows a flowchart representing an illustrative process 700 for generating one or more display elements in an XR environment. While the example shown in FIG. 7 refers to the use of system 100, as shown in FIG. 1, it will be appreciated that the illustrative process shown in FIG. 7, may be implemented, in whole or in part, on system 100 and system 200, either alone or in combination with each other, and/or any other appropriately configured system architecture.

At 702, control circuitry, e.g., control circuitry of XR device 110, initiates an XR session. For example, the XR session may be initiated by a user putting on XR device 110, or otherwise activating an XR system.

At 704, control circuitry, e.g., control circuitry of user device 102 and XR device 110, identifies a user device 102 associated with the XR session. For example, upon initiation of the XR session, XR device 110 may scan a vicinity for one or more user devices 102 operationally capable of interfacing with XR device 110 for generating one or more display elements 101 in an XR environment. For example, control circuitry may cause user device 102 and XR device 110 to become paired during the XR session.

At 706, control circuitry, e.g., control circuitry of XR device 110, determines a position of user device 102, e.g., in a manner similar to that described above. In the example shown in FIG. 7, 706 comprises 708 and 710.

At 708, control circuitry determines an anchor point 116 of a user device 102, e.g., in a manner similar to that described above. In some examples, the anchor point may be determined by accessing stored data relating to the configuration of the user device 102. For example, in response to user device 102 and XR device 110 becoming paired, control circuitry may identify a type of user device 102 access data relating to one or more possible anchor points 116 that can be used, e.g., as a center point, or an edge, of the user device 102 in the XR environment. For example, a manufacturer of a user device 102 may supply data relating to a particular anchor point 116 for a user device 102, e.g., so that the XR system need not compute the anchor point 116 of the user device 102 each time a user device 102 is used with the XR device 110.

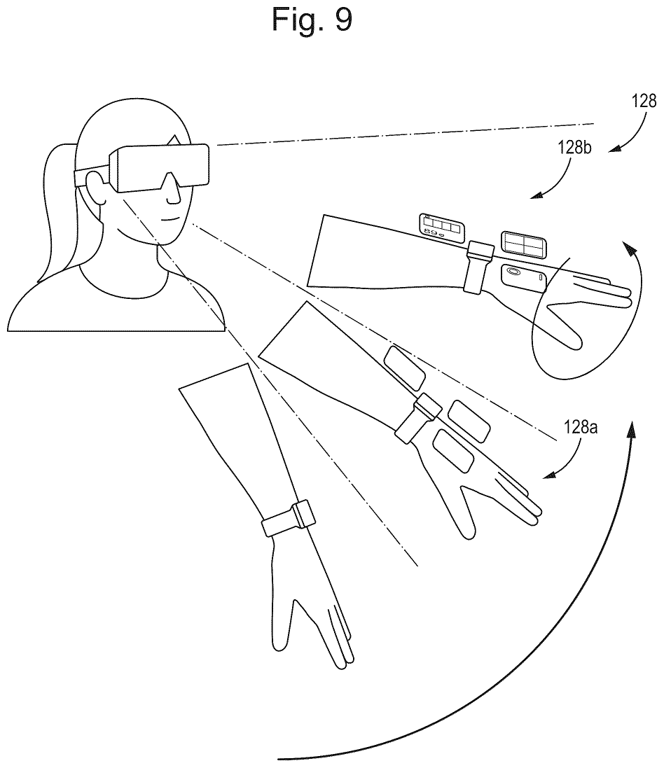

At 710, control circuitry, e.g., control circuitry of XR device 110, determines whether the user device 102 is within a predetermined region of the XR environment. FIGS. 8 and 9 illustrate examples a predetermined regions, e.g., relating to a field of view defined by an angular range of a total field of view of a user in the XR environment, and are discussed below in more detail. However, in other examples, the predetermined region of the XR environment may be any appropriate portion of an overall XR environment, such as an area in front of a user in the XR environment, and/or an area above a certain height in the XR environment, such as a waist-height. In some examples, a predetermined region may be specific to a user, or set of users. For example, a user may store in a user profile, e.g., accessed at 712, one or more preferences or settings relating to a configuration of a predetermined region. For example, a user may set a predetermined region to a first configuration for use in a first type of XR environment, such as a VR gaming environment, and a second configuration for use in a second type of XR environment, such as an AR environment. Irrespective of the type of the XR environment or the configuration of the predetermined region of the XR environment, when the user device 102 is within the predetermined region, process 700 moves to 714. When the user device is not within the predetermined region, process 700 moves back to 704. In this manner, computational operation used to generate the one or more display elements 101 can be minimized, e.g., so as to render the one or more display elements 101 in a position surrounding the user device 102 only when desired, such as when the user device 102 is in an area of the XR environment that is likely to be seen, or more easily seen, by the user.

At 714, control circuitry, e.g., control circuitry of XR device 110, generates for display one or more display elements 101 in the XR environment, e.g., in a manner similar to that described at 304. In the example shown in FIG. 7, 714 comprises 716 to 730.

At 716, control circuitry, e.g., control circuitry of XR device 110, generates for display one or more display elements 101 at an anchor point of the XR environment (e.g., see secondary anchor point 126 of FIG. 8, which is remote from user device 102). For example, control circuitry may access data, e.g., at 732, to determine a location of the anchor point 126 of the XR environment. In particular, the anchor point 126 may be a fixed location in the XR environment at which one or more display elements 101 may be generated for display and ready to be transferred to an anchor point 114 of the user device 102. In some examples, control circuitry generates a low quality version of a display element 101 for display at anchor point 126. Additionally or alternatively, when displayed at anchor point 126 a display element 101 may not be an interactive element, e.g., in the manner that it is when displayed at anchor point 114. In other words, a display element 101 is not operable to control user device 102 when the display element is located at anchor point 126, whereas a display element 101 is operable to control user device 102 when the display element is located at anchor point 114. Again, computational operation may be minimized by varying the operability of the display elements 101, e.g., based on anchor point location.

At 718, control circuitry, control circuitry of user device 102 and/or XR device 110, determines whether the user device 102 is within an orientation threshold. For example, control circuitry may use one or more sensors of the user device 102 and/or XR device 110 to determine it orientation, e.g., whether a screen of the user device 102 is orientated towards the user. Additionally or alternatively, a computer vision system of the XR device 110 may determine in which direction the user device 102 is pointing. When user device 102 is not within an orientation threshold, process 700 moves back to 710. When user device 102 is within the orientation threshold, process 700 moves to 720. Again, computational operation used to generate the one or more display elements 101 can be minimized, e.g., so as to render the one or more display elements 101 only when desired, such as when in an area of the XR environment that is likely to be seen, or more easily seen, by the user.

At 720, control circuitry, e.g., control circuitry of XR device 110, causes the one or more display elements 101 to transition from being located relative to anchor point 126 to being located relative to anchor point 114. For example, control circuitry may cause the one or more display elements 101 located at 126 to move through the XR environment towards the user device 102, e.g., at the user device 102 moves towards or within a predetermined region (e.g., as determined at 710) and/or an orientation threshold (as determined at 718). In some examples, a transition between display of the one or more display elements 101 may comprise a change in transparency of the one or more display elements 101. For example, as the user device 102 moves towards or into the predetermined region, but remains outside of the orientation threshold, the one or more display elements 101 may be displayed in a transparent state, and then become nontransparent at the user device 102 is oriented so as to face the user. In some examples, operation of the one or more display elements 101 may be limited when in a transparent state, e.g., to minimize computational operation when the user device 102 is not in a fully accessible/useable position.

In the example shown in FIG. 8, one or more display elements 101 are transferred from anchor point 126 to anchor point 114 when user device 102 is within a predetermined region 128 and orientated above an orientation threshold. However, in other examples, the one or more display elements 101 may be transferred from anchor point 126 to anchor point 114 when user device 102 is within a predetermined region 128, or, separately, when the user device 102 is orientated above an orientation threshold. For example, moving the user device 102 into predetermined region 128 may cause at least partial positional transfer of the one or more display elements 101. Alternatively, reorientating the user device 102 above an orientation threshold may cause at least partial positional transfer of the one or more display elements 101, e.g., where the XR environment does not implement a predetermined region 128. In some examples, reorientation of the user device 102 may be determined based on IMU data captured by the user device 102. For example, one or more orientation thresholds may be accessible by user device 102, and user device 102 may be configured to issue a notification to the XR device 110 when one or more orientation thresholds have be breach or met, e.g., based on sensor output and IMU data of the user device 102.

In the example shown in FIG. 8, the predetermined region 128 is defined as an angular range of a total field of view of the user. In some examples, the angular range may be defined, e.g., preset in a user profile, or automatically by a manufacturer of XR device 110, by an angle in one or more planes, e.g., by an angle (e.g., 45 degrees) in a vertical plane and an angle (e.g., 120 degrees) in a horizontal plane. In addition, the predetermined region 128 may be bounded by a terminating distance, e.g., a distance set by a length of a user's arm, or a dimension of a physical or virtual room. This may result in a predetermined region 128 having a frustrum-shaped (or otherwise shaped) volume in space in front of the user and/or XR device 110. In some examples, the predetermined region 128 may move relative to the user and/or XR device 110, e.g., so as to be provided in a substantially fixed location relative to the user as the user navigates the XR environment. In some examples, the size and/or shape of the field of view of the user may be determined by the one or more sensors of the XR device 110, such as one or more imaging sensors, including RGB cameras, IR cameras, depth cameras, a LIDAR system, etc., and/or movement sensors outputting IMU data relating to the movement of the XR device 110. In some examples, data received from the user device 102 may be used to at least partially determine the size and/or shape of the field of view of the user.

In particular, FIG. 8 shows user raising an arm so as to bring a user device 102 from a first position 130, which is below the predetermined region 128, to a second position 132, which is within the predetermined region 128. Upon the user device 102 moving to within (or to with a threshold distance of) the predetermined region 128, control circuitry causes display elements 101 to transition, e.g., visually, between anchor point 126 and anchor point 114. In the example shown in FIG. 8, the display elements 101 are arranged in a manner similar to that shown in FIG. 5, but may, however, be arranged in any appropriate manner. In some examples, the transition between anchor point 126 and anchor point 114 may be a fading-out of the display elements 101 at anchor point 126 and a fading-in of the display elements 101 at anchor point 114. In other example, the transition between anchor point 126 and anchor point 114 may comprise the display elements 101 moving through the XR environment, e.g., along a path defined by straight line or curve between anchor point 126 and anchor point 114 in the XR environment. In some examples, the speed of the transition may be based on the speed of the movement of the user device 102. For example, should a user raise their arm quickly, the transition from anchor point 126 to anchor point 114 may occur more quickly. Similarly, should the user's slowly drop back below the predetermined region 128, the transition to anchor point 126 from anchor point 114 may occur more slowly.

The example shown in FIG. 9 illustrates a user raising their arm in a manner similar to that shown in FIG. 8. However, in the example of FIG. 9, the predetermined region comprises a first portion, e.g., a lower region 128a of the predetermined region 128, and a second portion, e.g., an upper portion 128b of the predetermined region 128. As the user raises their arm, and hence the user device 102, into the lower region 128b, the display of the one or more display elements 101 transitions from being not shown to a transparent display mode. The display elements 101 may transition between anchor points, e.g., as shown in FIG. 8, or the display elements 101 may simply fade into a visible display state. When the user device 102 is in the lower region, the display elements 101 remains in a transparent display mode, e.g., at a 50% transparent level, irrespective of the orientation of the user device 102. When the user device 102 is in the upper region 128b, the display of the display elements 101 is further dependent on the orientation of the device. For example, as the user rotates their arm, so as to bring a screen of the user device 102 facing the user, control circuitry may cause the level of transparency of the display elements 101 to change. As discussed above, determination of the orientation of the user device 102 may be made in any appropriate manner, e.g., by virtue of the user device 102 exchanging inertial measurement units with the XR device 110. In some examples, control circuitry may determine whether the user device 102 is orientated at or above an orientation threshold. For example, an orientation threshold may be an absolute threshold, such as a vertical and/or horizontal threshold, or a relative threshold, e.g., an orientation relative to the user, e.g., an orientation facing the user. In the example shown in FIG. 9, the display of the display elements 101 is first transitioned to a transparent display mode by moving the user device 102 into the predetermined region 128, and then transitioned to a fully visible display mode by orientating the device towards the user (e.g., towards the XR device 110) when the user device 102 is in the upper region 128b of the predetermined region 128. However, a change in the display mode may be caused, e.g., only caused, by a reorientating the user device 102, e.g., without paying regard to the absolute position of the user device 102 in the XR environment. In addition to a change in the display mode of the display elements 101, functionality of a user interface of a display element 101 may depend on the position and/or the orientation of the user device 102. For example, a transparent display mode, e.g., that is implemented when the user device 102 is in the lower region 128a, may not implement functionality associated with a user interface of a display element 101. Whereas, a fully visible display mode may implement functionality associated with a user interface of a display element 101, thus allowing a user to provide input to the user interface for controlling the user device 102.

At 722, the one or more display elements 101 are generated for display relative to the anchor point 114, e.g., in a manner described at 304. In particular, at 722, functionality of the display elements 101 may be enabled, e.g., in response to the transition from anchor point 126. In other words, a user interface of each display element 101 may become functional so as to control user device 102, e.g., in response to the transition from anchor point 126. Moreover, the layout of the one or more display elements 101 in the XR environment may be determined based on a type of user input.

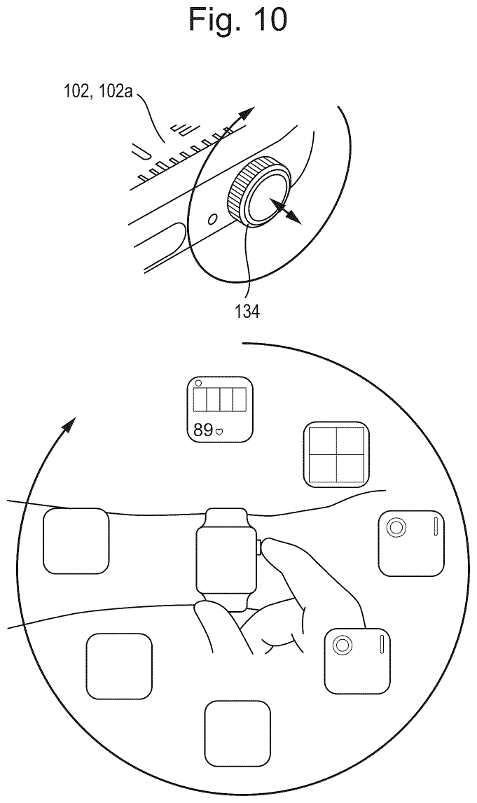

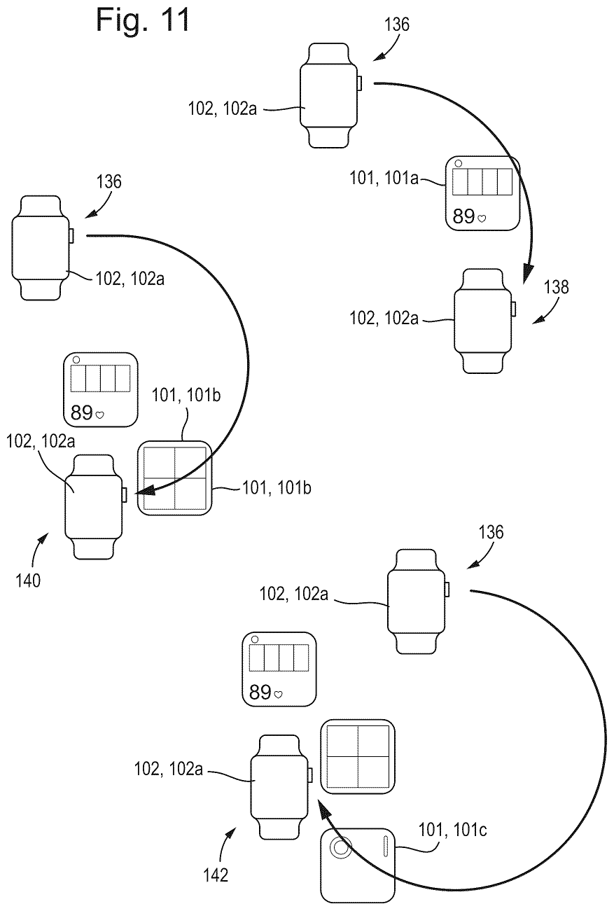

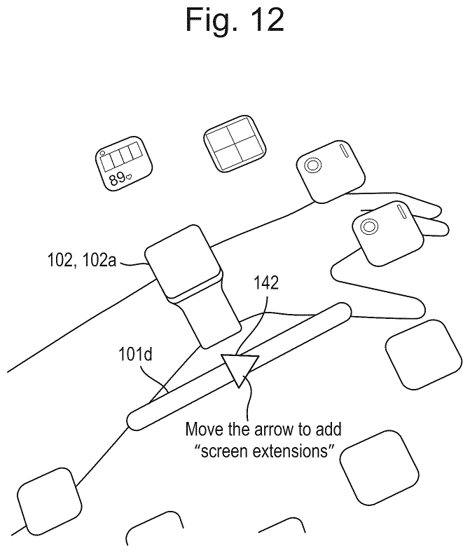

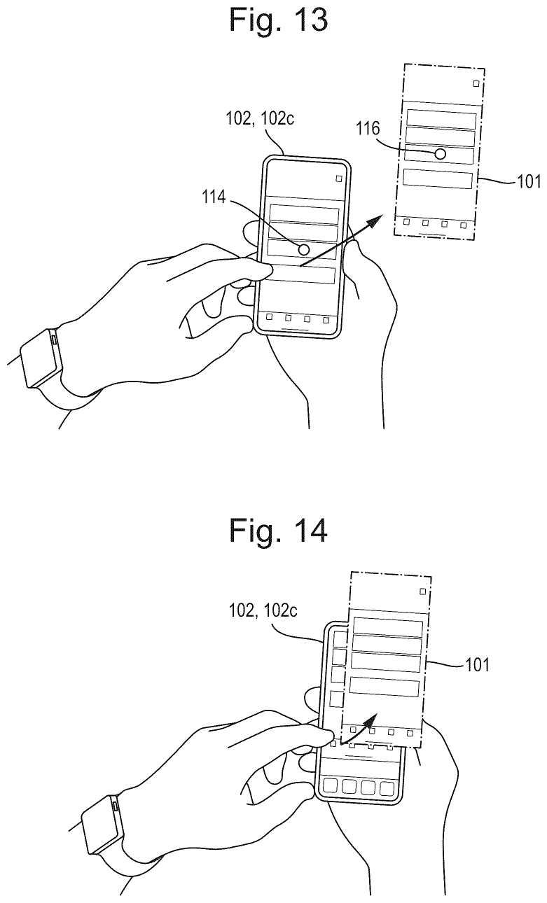

At 734, control circuitry, e.g., control circuitry of user device 102 and/or XR device 110, determines a type (or types) of user input. FIGS. 10-14 illustrate various types of user inputs that may cause the one or more display elements 101 to be set out in a certain layout or pattern, e.g., depending on the type of user input. For example, FIG. 10 illustrates how the layout of the display elements 101 may be controlled by virtue of interaction with the user device 102, FIG. 11 illustrates how the layout of the display elements 101 may be controlled by virtue of a gesture, FIG. 12 illustrates how the layout of the display elements 101 may be controlled by virtue of interaction with a virtual control element, FIG. 13 illustrates one way how the layout of the display elements 101 may be controlled by virtue of interaction with a touch screen of the user device 102, and FIG. 14 illustrates another way how the layout of the display elements 101 may be controlled by virtue of interaction with a touch screen of the user device 102.

In the example shown in FIG. 10, a user operates a control of user device 102 to determine a layout of the display elements 101. In particular, FIG. 10 shows a user turning a crown of a smart watch to determine the layout of the display elements 101. For example, the crown may be rotated to generate, in succession, the display of multiple display elements 101 relative to the user device 102. Additionally or alternatively, the visibility of the display elements 101 may be toggled by the crown of the smart watch. For example, the crown may be depressed once to activate the display of the display elements 101, and depressed again to deactivate the display of the display elements 101. Once activated, the layout may be controlled by rotating the crown. While the example illustrate the operation of a smart watch 102a, similar methodology may be implemented on a control of any appropriate user device 102 that may be used in the context of the present disclosure, such as a touch screen control of a user device 102, such as monitor 102, or a joystick of a user device 102, such a VR controller.

In the example shown in FIG. 11, the user makes a gesture to determine a layout of the display elements 101. For example, control circuitry of user device 102 and/or XR device 110 may determine the position of the user device 102 in the XR environment, and generate the display of the display elements 101 in a layout according to a type of gesture. In the example shown in FIG. 11, the user gestures to move user device 102, e.g., smart watch 102a, from a first position 136, to a second position 138, to a third position 140, and to a fourth position 142. For example, the user may wave their arm in a circular manner, moving the user device 102 through the first, second third and fourth positions 136, 138, 140, 142. As the user device 102 moves from the first position 136 to the second position 138 a first display element 101a is generated for display. As the user device 102 moves from the second position 138 to the third position 140 a second, additional, display element 101b is generated for display. As the user device 102 moves from the third position 140 to the fourth position 142 a third, additional, display element 101c is generated for display. Whilst the gesture in the example shown in FIG. 11 is a substantially circular movement, the gesture may be any appropriate type of movement. In some examples, control circuitry may be configured to detect one or more predetermined gestures. For example, a user may define one or more gestures to initiate the display of the display elements 101 in corresponding layouts. For example, a swipe left or right may cause one or more display elements 101 to appear in a line or arc corresponding to the gesture. In other examples, control circuitry may be configured to determine a gesture of the user, e.g., a wave or swipe of a hand not wearing or holding the user device 102. For example, a user may be wearing smart watch 102a on one hand and control circuitry may determine a gesture with the other hand, e.g., using a computer vision system of the XR device 110.

In the example shown in FIG. 12, the XR environment is a VR environment where smart watch 102a is a digital twin of a physical user device. in FIG. 12, the VR environment comprises an interactive display element 101d for controlling the layout of the display elements 101. For example, interactive display element 101d (e.g., a virtual control element) comprises a slider 144 that a user may move in the VR environment. The position of the slider 142 relates to how many display elements 101 are generated in a predetermined layout. The slider 142 may be controlled using any appropriate means, such as a gesture determined by control circuitry of the user device 102 and/or the XR device 110, and/or an input to a control of user device 102 (or any other device associated with the XR system). For example, the XR system may comprise one or more haptic wearables, e.g., a glove, configured to allow a user to interact with virtual objects, e.g., display elements 101, in the XR environment. In the context of the present disclosure, the use of such wearables is not confined the example shown in FIG. 12, and may be implemented in any other examples, where technically possible. While the layouts shown in FIGS. 10-12 are circular, the layout may be any appropriate shape or pattern, e.g., determined by a user preference, a setting of a manufacturer of a user device 102 or XR device 110, a setting of a service/content provider, or otherwise. In some examples, the shape or pattern of the layout may be based on the context of the XR environment. For example, control circuitry may control the layout or pattern of the display elements 101 based on with what and/or with whom a user is interacting in the XR environment. For example, control circuitry may set the layout or pattern so that the position of the display elements 101 does not interfere with or prevent the user from performing an action. In particular, the layout or pattern of the display elements 101 may be set so that the generated display elements 101 do not overlay a certain physical or virtual object, such as user device 102. Conversely, the layout or pattern of the display elements 101 may be set so that the generated display elements 101 at least partially obscure a certain physical or virtual object, such as user device 102.

In the example shown in FIG. 13, a user is interacting with user device 102, e.g., smartphone 102c, in an AR environment. In this case, the user can view the physical display screen of the user device 102, e.g., while wearing XR device 110. Control circuitry of the user device 102 detects an input, such as a swipe or a flick, to the screen of user device 102. In response, display element 101 is generated in the AR environment. In some examples, the direction of the display element 101 relative to anchor point 114 is determined by the direction of the gesture. Additionally or alternatively, the distance at which the display element 101 appears from the anchor point 114 may depend on the speed of the gesture. For example, should a user swipe gently to the left, the display element 101 may appear at a first distance relatively close to a lefthand edge of the user device 102. Whereas, should the user swipe up and right (as shown in FIG. 13) in a faster manner, the display element 101 may appear at a second distance relatively further from a top righthand corner of the user device 102. In some examples, the display element 101 may fade into visibility, e.g., centered at a point 116, in the AR environment. In other examples, the display element 101 may appear to move through the AR environment, e.g., away from anchor point 114 to center point 116. Once the display element 101 is at center point 116, the user may reposition the display element 101 in the AR environment, e.g., by virtue of further interaction with the screen of user device 102, and/or by a gesture, e.g., in free space. In the example shown in FIG. 13, the display elements 101 mimics the display of the physical screen of the user device 102, e.g., by default. However, in other examples, the display of the physical screen may change, e.g., in response to the display element 101 appearing in the AR environment. For example, the display of the screen of user device 102 may switch to displaying a predetermined application, or the last used application, for example.

In the example shown in FIG. 14, a display element 101 is generated overlaying the physical screen of the user device 102. For example, a center point 116 of display element 101 may be co-located with anchor point 114, such that the display element 101 maps, e.g., in size and shape, on to the physical display of the user device 102, so that the physical display cannot be seen by the user when in the AR environment. In the example shown in FIG. 14, control circuitry detects an input to the screen of the user device 102. For example, the user input may comprise the user maintaining contact with the screen of user device 102, e.g., for a predetermined period. In response, control circuitry may allow the user to move the display element 101 from its position to another position. For example, should the user touch, hold and drag a finger in a direction towards the upper righthand corner of the screen of the user device 102, the display element 101 may move in a corresponding manner. In other words, the user can drag the display element 101 from a position overlaying the screen of the user device 102 to a position in free space in the AR environment around the user device 102. Other user inputs may be a pinch and drop, or a gesture that allows the user to “peel” the display element 101 from its apparent position overlaying the screen of the user device 102. In some examples, the user input may be an input, such as a swipe gesture, to switch between applications executable by the user device 102. In response to the user repositioning the display element 101, another display element may appear in its place overlaying the screen of the user device 102, or the physical screen of the user device 102 may become visible in the AR environment. For the avoidance of doubt, the features described in relation to the examples shown in FIGS. 10-14 may be used in conjunction with each other, or independently from each other, where technical possible. Further, the examples shown in FIGS. 10-14 may be implemented in any appropriate type of XR environment.

At 734, control circuitry, e.g., control circuitry of user device 102 and/or XR device 110, monitors the position of the user device 102. For example, control circuitry may determine whether position of the user device 102 has changed relative to predetermined region 128 and/or whether the orientation of the user device 102 is still within the orientation threshold. In some examples, control circuitry determines whether the predetermined region and/or the orientation threshold has been updated, e.g., by virtue of user interaction with the XR environment (such as a change in a level of a game being played in the XR environment). When the control circuitry determines that the conditions of 710 and 718 are still satisfied, process 700 moves to 726. Although not shown in the flow chart of FIG. 7 for the sake of clarity, 724 may move back to either of 710 and 718 based on the user device 102 moving outside of the predetermined region 728 or the orientation threshold.

At 726, control circuitry, e.g., control circuitry of XR device 110, maintains the position of the one or more display elements 101 relative to the anchor point 114 of the user device 102, so that the one or more display elements 101 track with the user device 102 as the us moves within the XR environment (e.g., within the predetermined region 128 and the orientation threshold. In particular, a level of functionality of the one or more display elements 101 is maintained at 726, so that the user can maintain control of the user device 102, e.g., as the user device 102 remains at an accessible/useable position and orientation. In some examples, the pattern or layout of the one or more display elements 101 may vary. For example, while the one or more display elements 101 may remain centered about anchor point 114 of user device 102, the display elements 101 may cluster or huddle more closely around the user device 102 as the user brings the user device 102 closer towards themself, and the display elements 101 may disperse from around the user device 102 as the user moves the user device 102 further away. In this manner, the one or more display elements 101 may become increasingly accessible/usable depending on proximity to the user device 102.

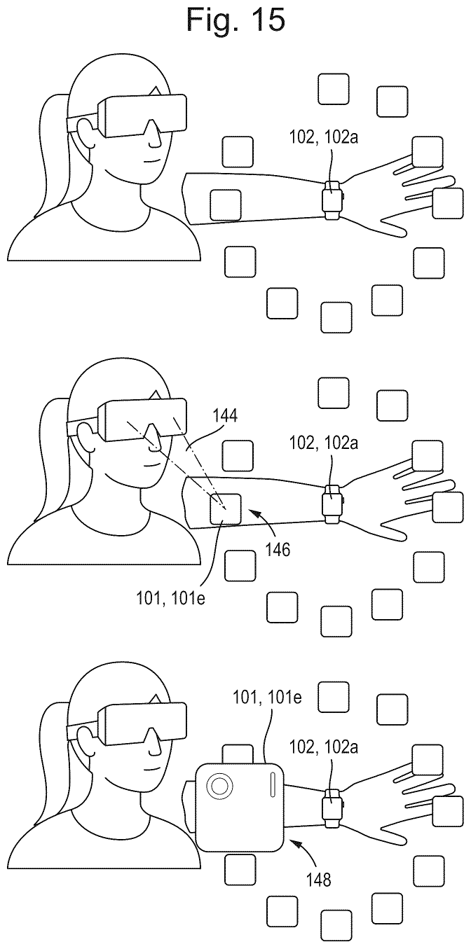

At 728, control circuitry, e.g., control circuitry of user device 102 and/or XR device 110, determines a level of interaction with at least one of the display elements 101. For example, control circuitry may determine whether a user is interacting with a user interface of a display element 101 to control user device 102. In the example shown in FIG. 15, control circuitry is configured to track a gaze of the user to determine whether a user is looking at a particular display element 101. For example, multiple display elements 101 may be generated for display in a circular pattern around user device 102, such as smartwatch 102a. XR device 110 may comprise gaze-tracking apparatus configured to determine a direction of the gaze of a user. In some examples, control circuitry may determine a spatial relationship between the anchor point 114 of the user device 102 and the XR device 110. For example, the spatial relationship may define a direction and distance of anchor point 114 from XR device 110. More specifically, control circuitry may determine a spatial relationship between one or more of the display elements 101 positioned relative to the anchor point 114, e.g., based on the position of the display elements 101 relative to the anchor point 114 and the spatial relationship between the anchor point 114 of the user device 102 and the XR device 110. For example, the spatial relationship may define a direction and distance of a display element 101 from XR device 110. In this manner, using the above determinations, control circuitry may be configured to compare the direction of a gaze of the user with the direction and distance of a display element 101 from XR device 110 to determine whether the user is looking at a display element 101. Control circuitry may be configured to monitor the duration of a fixed gaze of a user. For control circuitry may determine when the user's gaze is fixed, e.g., for a certain amount of time, or make a predetermined number of changes, e.g., over a certain amount of time. In this manner, control circuitry may increase a confidence level that a user is looking in a direction associated with a certain display element 101. In the example shown in FIG. 15, control circuitry determines that a user's gaze 144 is fixed on display element 101e. in response to the user's gaze being determined to be fixed, e.g., for a certain duration (i.e., a interaction threshold), control circuitry causes display element 101e to change in appearance, e.g., to allow the user to more easily access a user interface provided by display element 101e. For example, control circuitry may enlarge display element 101e to make it easier to see. Additionally or alternatively, a level of functionality of display element 101e may change based on the user's gaze. For example, when display element 101e is in a first display state 146, e.g., a display state matching the display state of the other display elements 101, display element 101e may have a first level of functionality, e.g., provided by a certain number (e.g., 2 or 3) of user selectable icons. When display element 101e is in a second display state 148, e.g., a display state differing from the display state of the other display elements 101, display element 101e may have a second level of functionality, e.g., provided by a greater number (e.g., 4 or 5) of user selectable icons. In some examples, the functionality of the other display elements 101, i.e., the display elements 101 at which the user is not looking, may be reduced, e.g., to zero, to conserve computational operation while the user is looking at, or interacting with, a particular display element 101e. In some examples, functionality may be reduced by changing the appearance and/or the position of the other display elements 101, e.g., to prevent user interaction with those display elements 101 from being above the interaction threshold, and/or to conserve computational operation while the user is looking at, or interacting with, a particular display element 101e. In response to determining that the level of interaction is above an interaction threshold, process 700 moves to 730. Conversely, when the level of interaction is less than an interaction threshold, process 700 moves back to 722.

At 730, control circuitry causes a change in the position and/or appearance of a display element 101 with which the user is interacting, e.g., display element 101d of FIG. 13. For example, control circuitry may increase the size of display element 101d, e.g., relatively to the other display elements 101. In this manner, the one or more display elements 101 may become increasingly accessible/usable depending on a level of suer interaction with a display element 101. In response to causing a change in the position and/or appearance of a display element 101, process 700 moves back to 728, e.g., to monitor the level of user interaction.

The actions or descriptions of FIG. 7 may be done in any suitable alternative orders or in parallel to further the purposes of this disclosure.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
determining, using control circuitry, a position of a user device in a field of view of a user in an XR environment;
generating for display, using the control circuitry, one or more display elements in the XR environment relative to the position of the user device in the field of view, wherein each display element comprises a user interface of an executable application for controlling the user device;
receiving, at the control circuitry, a command via the user interface for the respective executable application for controlling the user device; and
transmitting, using the control circuitry, an instruction to the user device to execute the command.

2. The method according to claim 1, wherein the executable application is executable by control circuitry of the user device.

3. The method according to claim 1, wherein the executable application is executable by control circuitry of a server operating in communication with the user device.

4. The method according to claim 1, wherein the one or more display elements are generated for display using control circuitry of an XR device operating in communication with the user device.

5. The method according to claim 1, the method comprising:
monitoring the position of the user device; and
updating the position of the one or more display elements in the XR environment as the position of the user device changes.

6. The method according to claim 1, the method comprising:
determining an anchor point of the user device; and
generating the one or more display elements relative to the anchor point.

7. The method according to claim 6, wherein the anchor point is determined by control circuitry of an XR device operating in communication with the user device.

8. The method according to claim 1, wherein the position of the one or more display elements in the XR environment relative to the position of the user device is defined by a predetermined layout corresponding to a type of user input, the method comprising:
determining a type of user input; and
generating the one or more display elements in the predetermined layout.

9. The method according to claim 1, wherein the position of the one or more display elements in the XR environment relative to the position of the user device is defined by a predetermined layout based on user activity relating to each executable application.

10. The method according to claim 1, the method comprising:
receiving a command to switch between usage of executable applications; and
generating for display the one or more display elements in response to receiving the command.

11. The method according to claim 1, the method comprising:
determining whether the user device is in a predetermined region of the field of view of the user in an XR environment; and
generating for display the display elements when the user device is within the predetermined region.

12. The method according to claim 11, the method comprising:
transitioning the one or more display elements between a first display state and a second display state as the user device moves into the predetermined region.

13. The method according to claim 12, wherein the transition between display states is based on a type of user input.

14. The method according to claim 12, the method comprising:
defining an anchor point of the XR environment; and
defining an anchor point of the user device, the method comprising:
transitioning the one or more display elements from the anchor point of the XR environment towards the anchor point of the user device as the user device moves into the predetermined region.

15. The method according to claim 1, the method comprising:
determining a level of user interaction with a first display element; and
modifying the position or appearance of the first display element in response to the level of user interaction being above a threshold level.

16. The method according to claim 1, the method comprising:
controlling the user interface provided by one of the display elements by virtue of user interaction with the user device.

17. The method according to claim 1, wherein the user device is a physical user device including a physical display screen, wherein the XR environment is an AR or MR environment provided using an AR or MR device, and wherein the executable application is running on the physical user device operating in communication with the AR or MR device, the method comprising:
rendering, using the AR or MR device, a display screen of the physical user device in the AR or MR environment; and
positioning, in the AR or MR environment, the display screen, rendered using the AR or MR device, relative to the physical display screen of the physical user device.

18. The method according to claim 1, wherein the XR environment is a VR environment and the user device is a physical user device, the method comprising:
rendering, using a VR device, a virtual twin of the physical user device; and
positioning, in the VR environment, the virtual twin based on a determined position of the physical user device.

19. The method according to claim 1, wherein the generation of the one or more display elements is predetermined based on a setting of the user device.

20. A system comprising:
memory configured to store an XR environment;
control circuitry configured to:
determine a position of the user device in a field of view of a user in the XR environment;
generate for display one or more display elements in the XR environment relative to the position of the user device in the field of view, wherein each display element comprises a user interface of an executable application for controlling the user device;
receive a command via the user interface for the respective executable application for controlling the user device; and
transmit an instruction to the user device to execute the command.

21-76. (canceled)
